(19) United States
(12) Patent Application Publication
(10) Pub. No.: US 2007/0030117 A1
(43) Pub. Date: Feb. 8, 2007

(54) CODED LOCK

(75) Inventor: You-Yi Li, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,694

(22) Filed: Apr. 22, 2006

(30) Foreign Application Priority Data
Aug. 5, 2005 (CN) 200510036440.3

(51) Int. Cl. H04L 9/32; G05B 19/00

(52) U.S. Cl. 340/5.54; 340/5.22

(57) ABSTRACT

A coded lock used in an electronic apparatus, the coded lock comprises an inputting circuit module for receiving a user input password, a control chip connected to the inputting circuit module to receive the input password, and an electronic lock connected to the control chip to lock and unlock a case of the electronic apparatus according to the input password.

### DESCRIPTION

1. Field of the Invention

The invention relates in general to a coded lock, more particularly to a coded lock which is used in an electronic apparatus to protect its components from being stolen.

2. Description of Related Art

Computer equipment, and intellectual property stored on hard disks in computer systems, can be worth millions of dollars to the owners. Particularly where small, expensive, and portable computers are involved, asset management is becoming very difficult.

As computers have become more common, theft of computers, of their components, and of the information stored in them has become more prevalent. Employees continue to be the primary source for losses due to theft. For example, employees who have compatible systems at home may be tempted to swap boards and input devices at work to repair their systems at home. Employees are not the only threat. Repairmen, janitors, delivery-persons, contractors, customers, invited guests, and even security people themselves have an opportunity to steal computer property.

The increasing use of plug-and-play and hot-swappable units has been helpful for thieves, since these architectures have accelerated moves toward modular components which can be quickly attached or removed from a system.

A conventional theft-prevention method is mounting a coded lock on a side face of a computer a code be input to allow access. U.S. Pat. No. 6,307,738 discloses a computer, which includes a microprocessor, a user input device which is operatively connected to provide input to the microprocessor, a memory which is connected to be read and write accessible by the microprocessor, and an output device connected to receive output from the microprocessor; an internal power supply connected to provide power to the microprocessor and the memory, the microprocessor, the memory, and the power supply all being locked by a case; and an electro-mechanical lock electronically controlled by the microprocessor to lock and unlock the case at a direction of a user through application software, wherein the electro-mechanical lock keeps the case in a locked position when the computer system is powered off.

The electro-mechanical lock is controlled by the application software only when the computer is on. If the computer can't be powered up, the computer remains locked up, so the conventional method is troublesome and inconvenient.

What is needed is a coded lock used in a computer which can be used to gain access to the computer whether the computer is on or off.

### SUMMARY OF THE INVENTION

A coded lock in accordance with a preferred embodiment of the present invention used in an electronic apparatus, the coded lock comprises an input circuit module for inputting a password, a control chip connected to the input circuit module to receive the password, and an electronic lock connected to the control chip to lock and unlock a case of the electronic apparatus when a correct password is input.

Other advantages and novel features will become more apparent from the following detailed description when taken in conjunction with the accompanying drawings, in which:

### BRIEF DESCRIPTION OF THE DRAWINGS

FIG. 1 is a partial view of a computer with a case unlocked, a locking mechanism, and a power input, in accordance with a preferred embodiment of the present invention;

FIG. 2 is a electrical configuration of some important parts of a computer system which include a coded lock in accordance with a preferred embodiment of the present invention; and

FIG. 3 is a block diagram of a circuit for use in the coded lock in accordance with the preferred embodiment of the present invention.

### DETAILED DESCRIPTION OF THE INVENTION

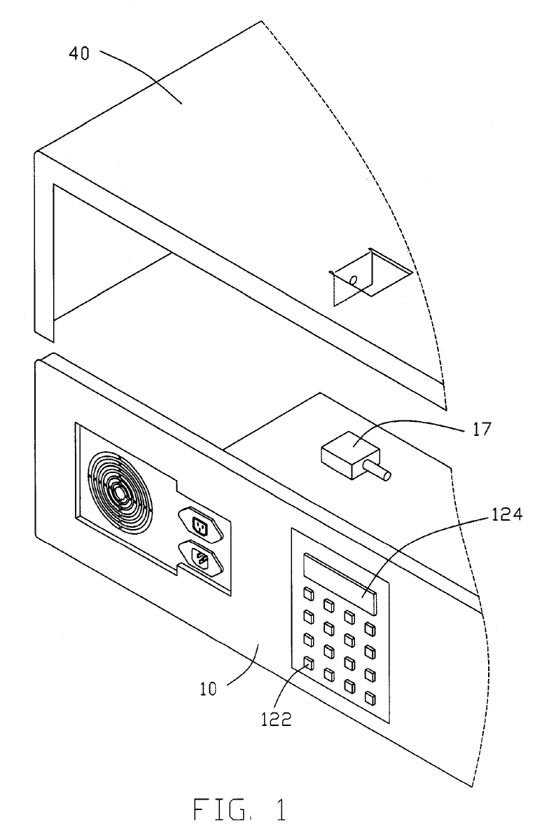

Referring to FIG. 1, a coded lock 17 in accordance with a preferred embodiment of the present invention is used in an electronic apparatus (the present invention takes a computer for example), the computer includes a base 10 and a cover 40 which can be fixed to the base 10.

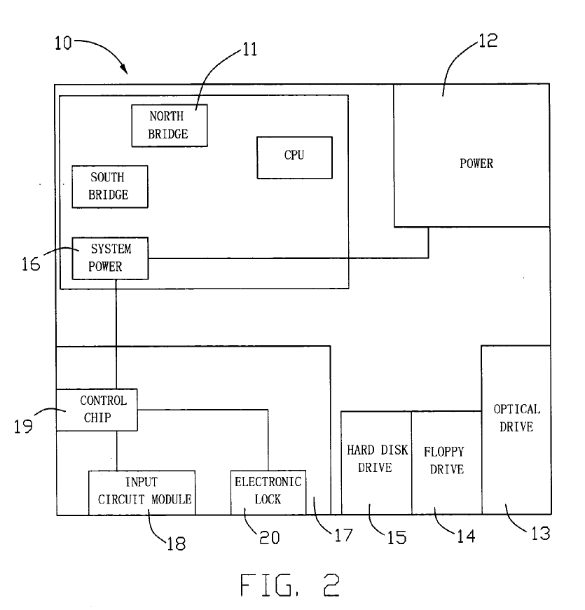

Referring also to FIG. 2, the base 10 is used to receive a plurality of electronic components such as a motherboard 11, a power supply 12, an optical driver 13, a floppy drivel 4, a hard disk driver 15 and so on. The motherboard 11 includes a CPU, a north bridge chip, a south bridge chip, and a system power supply 16; the system power supply 16 is connected to the power supply 12. The coded lock 17 includes an input circuit module 18, a control chip 19, and an electronic lock 20. The input circuit module 18 is provided for inputting a password to the control chip 19, the electronic lock 20 locks the cover 40 to the base 10, the control chip 19 controls switching of the electronic lock 20 according to the input password.

A working voltage of the control chip 19 is provided by the system power 16 or an exterior direct-current power supply (not shown), generally the working voltage is +5V. The input circuit module 18 is coupled to an input device such as a keypad 122 (see FIG. 1), the input circuit module 18 is provided for receiving information from the keypad 122. The control chip 19 scans the input passwords of the input circuit module 18, and the control chip 19 in this embodiment is a PIC16F54.

The user establishes preset passwords, the preset passwords include two passwords: one is an administrator level password, and the other is a user level password. In regional network management, an administrator can establish and revise the administrator password and the user password; the user can only establish and revise the user password.

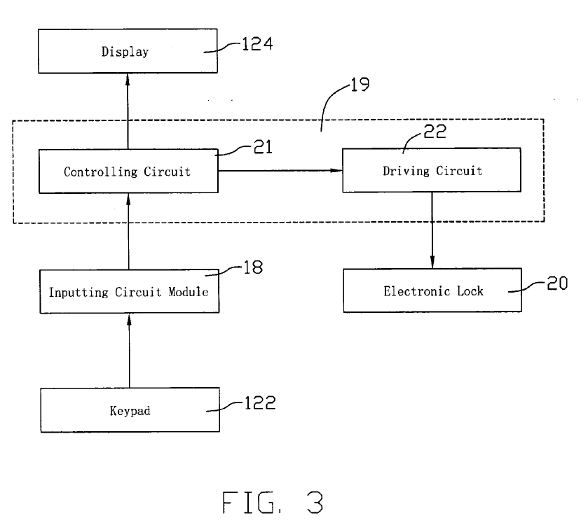

Referring to FIG. 3, the control chip 19 includes a controlling circuit 21 and a driving circuit 22. The inputting circuit module 18 transmits the input password into an input of the controlling circuit 21. A display 124 is coupled to the controlling circuit 21 to display information from the controlling circuit 21. The controlling circuit 21 compares the input password with the preset passwords. If the input password matches one of the preset passwords, then the display 124 provides an interface window. The interface window includes an “on” option to unlock the electronic lock 20, an “off” option to lock the electronic lock 20 and a “setting” option to establish and revise the administrator password or the user password corresponding to level of the password input.

When the “on” option is chosen the controlling circuit 21 produces a first controlling signal, then the first controlling signal is transmitted to an input of the driving circuit 22. The driving circuit 22 produces a first driving signal according to the first controlling signal. The first driving signal is transmitted to the electronic lock 20 to execute an unlocking function.

When the “off” option is chosen the controlling circuit 21 produces a second controlling signal, the second controlling signal is transmitted to the input of the driving circuit 22. The driving circuit 22 produces a second driving signal according to the second controlling signal. The second driving signal is transmitted to the electronic lock 20 to execute locking function.

When the “setting” option is chosen the preset password/s can be re-established, changed, or deleted.

The electronic lock 20 is mounted on the base 10, when the electronic lock 20 is locked it will not unlocked unless one of the preset passwords is input and the ‘on’ option selected. The control chip 19 controls the electronic lock 20 independently and the electronic lock 20 doesn't need a software application to control the switching, so the electronic lock 20 whether the computer is powered on or off.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A coded lock used in an electronic apparatus, the coded lock comprising:
an inputting circuit module for inputting a password;
a control chip independent of the electronic apparatus connected to the inputting circuit module to receive the input password; and
an electronic lock connected to the control chip to lock and unlock a case of the electronic apparatus according to the input password whether the electronic apparatus is powered on or off.

2. The coded lock as claimed in claim 1, wherein the inputting circuit module is coupled to a keypad to receive user input.

3. The coded lock as claimed in claim 1, wherein the control chip is a PIC16F54 chip.

4. The coded lock as claimed in claim 1, wherein a system power source is connected to the electronic apparatus to provide power to the control chip.

5. The coded lock as claimed in claim 1, wherein the control chip includes a controlling circuit and a driving circuit, the inputting circuit module transmits the input password to an input of the controlling circuit.

6. The coded lock as claimed in claim 5, wherein a display is coupled to the controlling circuit, the controlling circuit compares the input password with a preset password, when the input password matches the preset password the display provides an interface window.

7. The coded lock as claimed in claim 6, wherein the interface window includes an “on” option to unlock the electronic lock, an “off” option to lock the electronic lock and a “setting” option to establish and/or revise the preset password.

8. The coded lock as claimed in claim 7, wherein when the “on” option is chosen the controlling circuit produces a first controlling signal, then the first controlling signal is transmitted to an input of the driving circuit, the driving circuit produces a first driving signal according to the first controlling signal, the first driving signal is transmitted to the electronic lock to execute an unlocking function.

9. The coded lock as claimed in claim 7, wherein when the “off” option is chosen the controlling circuit produces a second controlling signal, then the second controlling signal is transmitted to the input of the driving circuit, the driving circuit produces a second driving signal according to the second controlling signal, the second driving signal is transmitted to the electronic lock to execute a locking function.

10. The coded lock as claimed in claim 7, wherein when the “setting” option is chosen the preset password is to be reset.

11. A method of providing physical protection to an electronic apparatus, comprising the steps of:
providing an inputting circuit module to input a password;
electronically connecting a control chip independent of the electronic apparatus to the inputting circuit module to receive the input password; and
electronically connecting an electronic lock to the control chip to lock and unlock a case of the electronic apparatus according to the input password whether the electronic apparatus is powered on or off.

12. The method as claimed in claim 11, wherein the inputting circuit module is coupled to a keypad □receive user input.

13. The method as claimed in claim 11, wherein the control chip includes a controlling circuit and a driving circuit, the inputting circuit module transmits the input password to an input of the controlling circuit.

14. The method as claimed in claim 13, wherein a display is coupled to the controlling circuit, the controlling circuit compares the input password with a preset password, when the input password matches the preset password the controlling circuit provides an interface window.

15. The method as claimed in claim 14, wherein the interface window includes an “on” option to unlock the electronic lock, an “off” option to lock the electronic lock, and a “setting” option to establish and/or revise the preset password.

16. The method as claimed in claim 15, wherein when the “on” option is chosen the controlling circuit produces a first controlling signal, then the first controlling signal is transmitted to an input of the driving circuit, the driving circuit produces a first driving signal according to the first controlling signal, the first driving signal is transmitted to the electronic lock to execute an unlocking function.

17. The method as claimed in claim 15, wherein when the “off” option is chosen the controlling circuit produces a second controlling signal, then the second controlling signal is transmitted to the input of the driving circuit, the driving circuit produces a second driving signal according to the second controlling signal, the second driving signal is transmitted to the electronic lock to execute a locking function.

18. The method as claimed in claim 15, wherein when the “setting” option is chosen the preset password is to be reset.
